(19) United States
(12) Patent Application Publication
(10) Pub. No.: US 2026/0097573 A1
(43) Pub. Date: Apr. 9, 2026

(54) Crack Proof Free Floating Cushioned Athletic Court Overlay System

(71) Applicant: Cushionguard, Inc., Liburn, GA (US)

(72) Inventors: Gerald J. Gauthier, Lavonia, GA (US); Richard H. Falcon, Milton, GA (US)

(21) Appl. No.: 19/351,696

(22) Filed: Oct. 7, 2025

Related U.S. Application Data
(60) Provisional application No. 63/704,201, filed on Oct. 7, 2024.

(51) Int. Cl. B32B 5/24; B32B 5/02; B32B 5/18; B32B 27/12; B32B 27/40

(52) U.S. Cl. CPC B32B 5/245; B32B 5/022; B32B 5/18; B32B 27/12; B32B 27/40; B32B 2250/04; B32B 2255/02; B32B 2255/26; B32B 2262/0284; B32B 2262/101; B32B 2266/0278; B32B 2307/72

(57) ABSTRACT

Various examples are provided related to cushioned athletic court overlay systems. In one example, an overlay mat includes a non-woven fleece backing fabric; a foam cushioning layer on the non-woven fleece backing fabric; a sheet of stabilizing material on the foam cushioning layer; and an acrylic coating system on the sheet of stabilizing material. In another example, a method for installing an overlay system includes positioning overlay mats on a supporting surface with edges of adjacent overlay mats abutting each other; installing reinforced fabric along edges of the overlay mats; installing fiberglass mesh over seams of the overlay mats; applying a cushion base coating over the fiberglass mesh and the overlay mats; and applying a fabric sealer over the cushion base coating and the overlay mats. A seam sealer can be applied between the overlay mats prior to installing the reinforced fabric to ensure the system remains free floating.

### CROSS REFERENCE TO RELATED APPLICATIONS

This application claims priority to, and the benefit of, co-pending U.S. provisional application entitled “Crack Proof Free Floating Cushioned Athletic Court Overlay System” having Ser. No. 63/704,201, filed Oct. 7, 2024, which is hereby incorporated by reference in its entirety.

### BACKGROUND

Traditional athletic courts constructed of asphalt or concrete are inevitably prone to cracking. Cracking is the most common problem with asphalt courts and is expected with exposure to weather and aging. As asphalt ages, it oxidizes and becomes brittle, making it more susceptible to significant cracking. Concrete courts are difficult for acrylic coatings to adhere properly and concrete is also susceptible to spalling. Concrete courts traditionally have expansion joints cut into the slab which will reflect through acrylic coatings. There is no type of crack filler material that is used for athletic courts that will keep the crack closed from extreme heat and cold temperature fluctuations. The industry uses crack repair systems that bridge the existing cracks but will not prevent additional cracking elsewhere or stop the treated cracks from elongating.

### SUMMARY

Aspects of the present disclosure are related to athletic court overlay systems. In one aspect, among others, an overlay mat comprises a non-woven fleece backing fabric; a foam cushioning layer disposed on the non-woven fleece backing fabric; a sheet of stabilizing material disposed on the foam cushioning layer; and an acrylic coating system disposed on the sheet of stabilizing material. In one or more aspects, the acrylic coating system can comprise an elastomeric polyurethane laminate or coating; and an acrylic coated non-woven fabric disposed over the elastomeric polyurethane laminate or coating. The acrylic coated non-woven fabric can comprise 100% polyester fabric. The sheet of stabilizing material can comprise a fiberglass sheet. In various aspects, the foam cushioning layer can comprise polyurethane foam with a density in a range from about 15 lbs./cu. ft. to about 40 lbs./cu. ft., or the density can be in a range from about 24 lbs./cu. ft. to about 30 lbs./cu. ft. The foam cushioning layer can comprise mechanically frothed polyurethane foam. The non-woven fleece backing fabric can comprise 100% PET Blend non-woven fleece.

In another aspect, a method for installing an overlay system comprises positioning a plurality of overlay mats of any of the above aspects on a supporting surface with edges of adjacent overlay mats abutting each other; installing reinforced fabric along edges of the plurality of overlay mats; installing fiberglass mesh over seams of the plurality of overlay mats; applying a cushion base coating over the fiberglass mesh and the plurality of overlay mats; and applying a fabric sealer over the cushion base coating and the plurality of overlay mats. In one or more aspects, the method comprises applying a plurality of coats of a resurfacer coating over the coated fiberglass mesh and the fabric sealer. In various aspects, one coat of the cushion base coating can be applied over the fiberglass mesh and at least one coat of a resurfacer coating can be applied over the coated fiberglass mesh and the fabric sealer. The resurfacer coating can comprise a flexible self-crosslinking acrylic coating. The flexible self-crosslinking acrylic coating can be 100% acrylic. The method can further comprise applying a color coating over the resurfacer coating. The color coating can comprise a flexible self-crosslinking acrylic coating. The flexible self-crosslinking acrylic coating can be 100% acrylic. The method can further comprise applying playing lines over the color coating. In some aspects, the fiberglass mesh can be a 9 inch plain weave fiberglass mesh. The reinforced fabric can comprise 4 inch polyester fabric reinforced with polyester scrim affixed over the seams of the plurality of overlay mats and 6 inch polyester fabric reinforced with polyester scrim around outer edges of the plurality of overlay mats. The method can further comprise preparing the supporting surface prior to positioning the plurality of overlay mats. The method can comprise applying a seam sealer between the plurality of overlay mats prior to installing the reinforced fabric along the edges of the plurality of overlay mats.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a cushioned athletic court overlay mat, in accordance with various embodiments of the present disclosure.

FIG. 2 illustrates example of an installation of a cushioned overlay system, in accordance with various embodiments of the present disclosure.

FIG. 3 is a flowchart illustrating an example of a method for installing an overlay system, in accordance with various embodiments of the present disclosure.

### DETAILED DESCRIPTION

Disclosed herein are various examples related to athletic court overlay systems. Reference will now be made in detail to the description of the embodiments as illustrated in the drawings, wherein like reference numbers indicate like parts throughout the several views.

Asphalt and concrete courts are considered hard courts with little or no shock absorption. There are several synthetic materials used as cushioned systems, and each one has its own application but also it's own disadvantages.

Synthetic clay courts require daily maintenance, irrigation, and adding additional materials after usage. Most 4 mm or 6 mm cushion rubber courts are adhered directly to the subsurface, and because it's a relatively new material there is no long-term data on longevity and reflective cracking. Synthetic turf with a foam backing has also been used but does not play like a traditional hard tennis court and requires weekly maintenance. Cushioned courts expand and contract at different rates than traditional hard courts which can cause micro-fractures that turn into surface cracks and cause delamination. Moisture absorbency has also been an issue in synthetic courts, especially with the polyethylene foam material. With the rise in popularity of the sport of pickleball, some cushioned courts do not provide consistent or adequate bounce of the pickleball.

This disclosure presents a crack proof free-floating cushioned Athletic court overlay system that provides playability for all sports including pickleball. This overlay system can be installed over the entire surface and allows any cracking in the base material to open and close with temperature fluctuations without reflecting through the overlay mat or coating materials. This system uses a non-woven fleece backing fabric which adds resistance between the mat and the base and allows the material to better follow the contour of the existing base. This backing material also reduces the expansion and contraction of the entire overlay mat system. The system includes an acrylic coating system that reduces moisture absorbency and will reduce the microfracturing of the acrylic coatings that can occur with standard coatings on cushioned athletic courts. This coating system is intended specifically for this crack proof free floating cushioned athletic court overlay system.

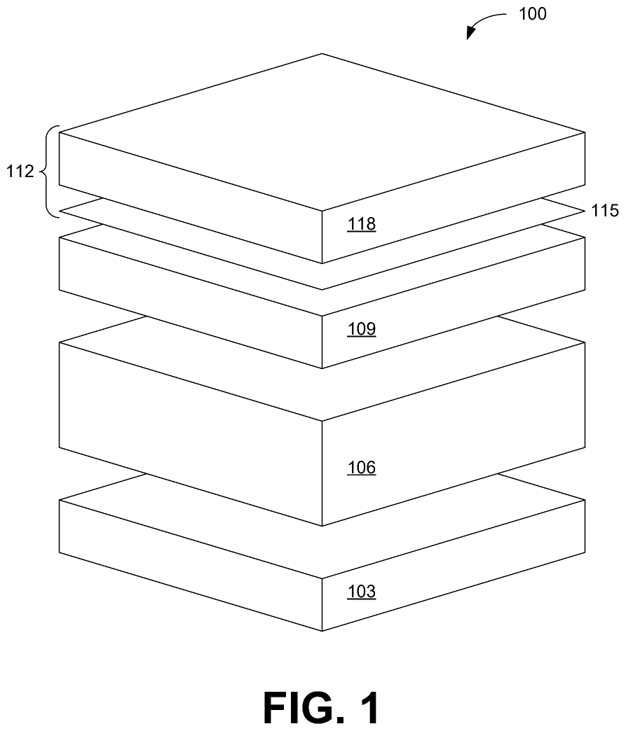

Referring to FIG. 1, shown is an example of a cushioned athletic court overlay mat 100, which can be fabricated as stabilized fabric and polyurethane composite overlay mats. For example, the composite overlay mat can be a 6-foot mat or other appropriately sized mat as needed. As illustrated in the example of FIG. 1, the overlay mat 100 can comprise a non-woven fleece backing fabric 103; a foam cushioning layer 106 disposed on the non-woven fleece backing fabric 103; a sheet of stabilizing material 109 disposed on the foam cushioning layer 106; and an acrylic coating system 112 disposed on the sheet of stabilizing material 109. The acrylic coating system can comprise an elastomeric polyurethane laminate or coating 115 disposed on the sheet of stabilizing material 109 and an acrylic coated non-woven fabric 118 disposed over the elastomeric polyurethane laminate or coating 115 as shown in FIG. 1.

The acrylic coated non-woven fabric 118 can comprise 100% polyester fabric. For example, the acrylic coated non-woven fabric 118 can be, e.g., 9.0 oz./yd² 100% Polyester Acrylic Coated Non-woven fabric or other appropriate weight of 100% Polyester Acrylic Coated Non-woven fabric. For instance, the 100% Polyester Acrylic Coated Non-woven fabric can be in a range from about 7.0 oz./yd² to about 11.0 oz./yd². The elastomeric polyurethane laminate or coating 115 can be in a range from, e.g., about 50.0 oz./yd² to about 55.0 oz./yd². The sheet of stabilizing material 109 can comprise a fiberglass sheet such as, e.g., from about 2.0 oz./yd² to about 2.5 oz./yd² fiberglass sheet stabilizing material. (Note—these specifications shown above have a +/−10% tolerance range.)

The foam cushioning layer 106 can comprise a polyurethane foam with a density in a range from, e.g., about 15 lbs./cu. ft. to about 40 lbs./cu. ft., or in a range from about 24 lbs./cu. ft. to about 30 lbs./cu. ft. The overlay mats can be available in different weights and densities. For example, the cushion density can be about 24 lbs./cu. ft. or about 30 lbs./cu. ft. The foam cushioning layer 106 can comprise mechanically frothed polyurethane foam. The mechanically frothed polyurethane foam can be in a range from about 28.0 oz./yd² to about 32.0 oz./yd². The cushion density can vary with application and playing characteristics as desired. The non-woven fleece backing fabric 103 can comprise 100% PET Blend non-woven fleece. The 100% PET Blend non-woven fleece can be in a range from, e.g., about 4.5 oz./yd² to about 5.5 oz./yd². (Note—these specifications shown above have a +/−10% tolerance range.)

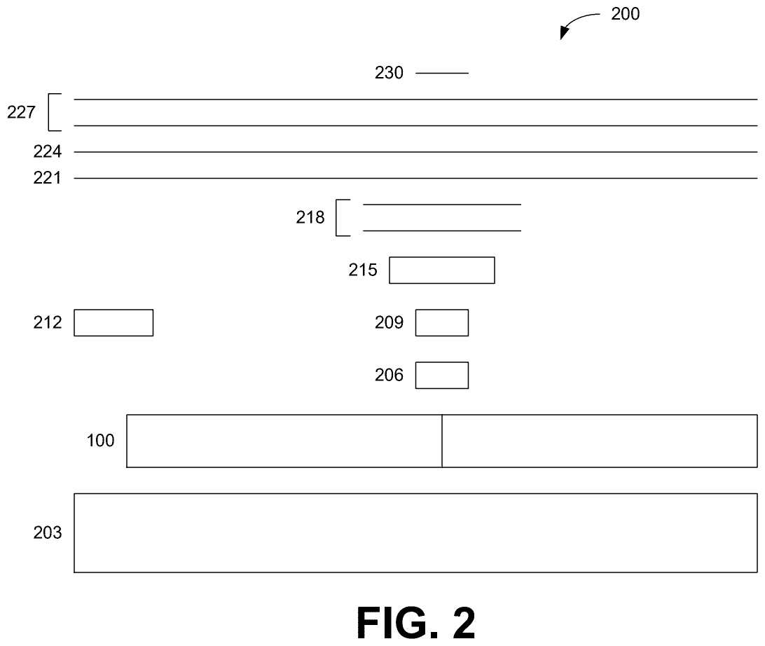

Referring next to FIG. 2, shown is an example of an installation of a cushioned overlay system 200 including cushioned overlay mats. The existing pavement or concrete base 203 is prepared prior to the installation of the overlay system. All cracks, low spots, post footings or any other areas that affect playability can be addressed using materials and standards established by the American Sports Builders Association. All repairs can be sanded smooth and the court can be cleaned and free of all debris.

Starting at the outside edge of the court, the first cushioned overlay mat 100 can be rolled out and placed a defined distance (e.g., 6 inches) from the edge of the fence (or other defined area). The next cushioned overlay mat 100 can then be rolled in the same direction and can be placed next to the previous mat. All cushioned overlay mats 100 can be rolled out in the same fashion until the entire court is covered. All mats 100 should be laying flat on the base 203 with no air pockets or ripples underneath. The edges of the mats 203 are rough cut to be able to move freely without interference of fences or posts.

The cushioned overlay mats 100 are unrolled and abutted not to leave a gap between rolls. The edges of the cushioned overlay mats 100 can be marked with chalk a defined distance (e.g., 6 inches) from the fence and the excess material trimmed and removed.

An acrylic seam sealer 206 can be applied between each joint of the cushioned overlay mats 100. The acrylic seam sealer 206 can be a 100% fortified acrylic seam sealer coating. This will ensure that the court will remain free-floating and not glued to the base 203.

Next, a polyester fabric reinforced with polyester scrim 209 (e.g., a 4″ polyester fabric reinforced with polyester scrim) can be installed to seam the cushioned overlay mats 100 together. The fabric 209 can be adhered to the mats 100 using fabric adhesive. Another polyester fabric reinforced with polyester scrim 212 (e.g., a 6″ polyester fabric reinforced with polyester scrim) can be installed on the edge of the cushioned overlay mats 100 on the perimeter of the court using the fabric adhesive. For example, the fabric 212 can be 3″ on the cushioned overlay mat 100 and 3″ on the court base 203.

After the fabric adhesive has dried, a plain weave fiberglass mesh 215 (e.g., a 9″ plain weave fiberglass mesh plain weave fiberglass mesh) can be installed over all overlay mat seams. The fiberglass mesh 215 can be adhered using an acrylic glue, which can be specifically designed for fabric and fiberglass crack repair systems. Apply a minimum of 2 coats of cushion base material 218 over the fiberglass mesh 215. The cushion base material can be a self-crosslinking 100% acrylic coating.

After the cushion base material 218 has dried, one (or more) coat of fabric sealer 221 can be applied. The fabric sealer 221 is a highly flexible, self-crosslinking 100% acrylic coating intended for the overlay system. The self-crosslinking refers to the film formation process, which provides better water resistance, flexibility, and strength.

A minimum one coat of flexible self-crosslinking 100% acrylic resurfacer coating 224 for cushioned surfaces can be applied over the entire overlay mat surface. A minimum of two coats of flexible self-crosslinking 100% acrylic color coating 227 for cushioned surfaces can be applied over the entire overlay mat surface. Flexible self-crosslinking 100% acrylic playing lines 230 can then be applied.

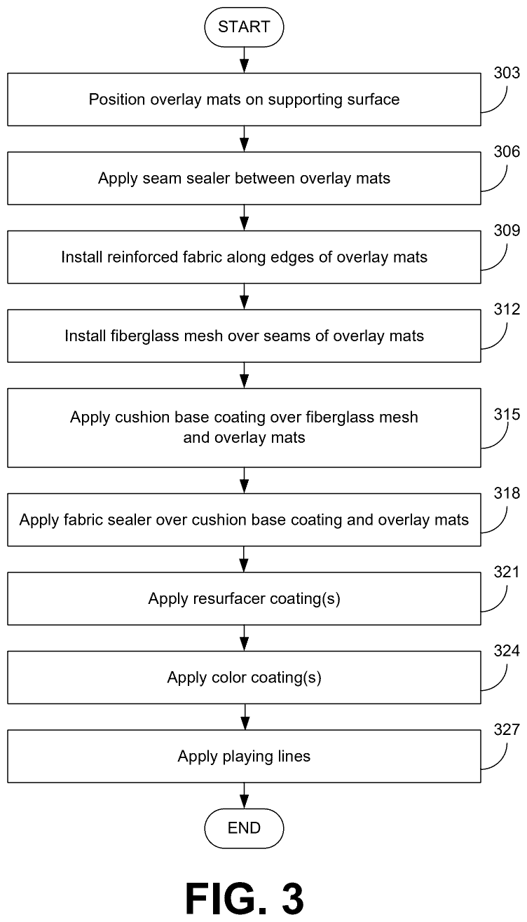

Referring to FIG. 3, shown is a flowchart illustrating an example of a method for installing an overlay system. Beginning at 303, a plurality of overlay mats 100 can be positioned on a supporting surface 203. The overlay mats 100 are positioned with edges of adjacent overlay mats abutting each other. An acrylic seam sealer coating 206 (e.g., 100% fortified acrylic seam sealer) can be applied between the overlay mats 100 at 306 to ensure the system remains free floating and not adhered to the base. Reinforced fabric 209/212 can be installed along edges of the plurality of overlay mats 100 at 309. Fiberglass mesh 215 can be installed over seams of the plurality of overlay mats 100 at 312. Next, a cushion base coating 218 can be applied over the fiberglass mesh 215 and plurality of overlay mats 100 at 315 and a fabric sealer 221 can be applied over the reinforced fabric 209 and the cushion base coating 218 can be applied over the fiberglass mesh 215 and and plurality of overlay mats 100 at 318. One or more resurfacer coating 224 can be applied over the coated fiberglass mesh 215/218 and the fabric sealer 221 at 321. One or more color coating 227 can be applied at 324 and playing lines 230 can be applied at 327.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An overlay mat, comprising:
a non-woven fleece backing fabric;
a foam cushioning layer disposed on the non-woven fleece backing fabric;
a sheet of stabilizing material disposed on the foam cushioning layer; and
an acrylic coating system disposed on the sheet of stabilizing material.

2. The court overlay mat of claim 1, wherein the acrylic coating system comprises:
an elastomeric polyurethane laminate or coating; and
an acrylic coated non-woven fabric disposed over the elastomeric polyurethane laminate or coating.

3. The court overlay mat of claim 2, wherein the acrylic coated non-woven fabric comprises 100% polyester fabric.

4. The court overlay mat of claim 1, wherein the sheet of stabilizing material comprises a fiberglass sheet.

5. The court overlay mat of claim 1, wherein the foam cushioning layer comprises polyurethane foam with a density in a range from about 15 lbs./cu. ft. to about 40 lbs./cu. ft.

6. The court overlay mat of claim 5, wherein the density is in a range from about 24 lbs./cu. ft. to about 30 lbs./cu. ft.

7. The court overlay mat of claim 5, wherein the foam cushioning layer comprises mechanically frothed polyurethane foam.

8. The court overlay mat of claim 1, wherein the non-woven fleece backing fabric comprises 100% PET Blend non-woven fleece.

9. A method for installing an overlay system, comprising:
positioning a plurality of overlay mats of claim 1 on a supporting surface with edges of adjacent overlay mats abutting each other;
installing reinforced fabric along edges of the plurality of overlay mats;
installing fiberglass mesh over seams of the plurality of overlay mats;
applying a cushion base coating over the fiberglass mesh and the plurality of overlay mats; and
applying a fabric sealer over the cushion base coating and the plurality of overlay mats.

10. The method of claim 9, comprising applying a plurality of coats of a resurfacer coating over the coated fiberglass mesh and the fabric sealer.

11. The method of claim 9, wherein one coat of the cushion base coating is applied over the fiberglass mesh and at least one coat of a resurfacer coating is applied over the coated fiberglass mesh and the fabric sealer.

12. The method of claim 11, wherein the resurfacer coating comprises a flexible self-crosslinking acrylic coating.

13. The method of claim 12, wherein the flexible self-crosslinking acrylic coating is 100% acrylic.

14. The method of claim 9, further comprising applying a color coating over the resurfacer coating.

15. The method of claim 14, wherein the color coating comprises a flexible self-crosslinking acrylic coating.

16. The method of claim 15, wherein the flexible self-crosslinking acrylic coating is 100% acrylic.

17. The method of claim 14, further comprising applying playing lines over the color coating.

18. The method of claim 9, wherein the fiberglass mesh is a 9 inch plain weave fiberglass mesh.

19. The method of claim 9, wherein the reinforced fabric comprises 4 inch polyester fabric reinforced with polyester scrim affixed over the seams of the plurality of overlay mats and 6 inch polyester fabric reinforced with polyester scrim around outer edges of the plurality of overlay mats.

20. The method of claim 9, further comprising preparing the supporting surface prior to positioning the plurality of overlay mats.

21. The method of claim 9, comprising applying a seam sealer between the plurality of overlay mats prior to installing the reinforced fabric along the edges of the plurality of overlay mats.
